(19) United States
(12) Patent Application Publication
(10) Pub. No.: US 2018/0155245 A1
(43) Pub. Date: Jun. 7, 2018

(54) High Pressure Laminate and Production Method Thereof

(71) Applicant: Taishan City DragonBoard Technologies Limited, Taishan City (CN)

(72) Inventor: Eddie Waiho CHU, New York, NY (US)

(21) Appl. No.: 15/665,380

(22) Filed: Jul. 31, 2017

(30) Foreign Application Priority Data
Dec. 7, 2016 (CN) 201611118212.5

(51) Int. Cl. C04B 28/10; C04B 40/02; C04B 41/00

(52) U.S. Cl. CPC C04B 28/105; C04B 41/009; C04B 40/0254

(57) ABSTRACT

The present invention discloses a decorative High Pressure Laminate (HPL) and production method thereof, which relates to the technical field of building decoration materials. The raw materials of HPL may include magnesium oxide, magnesium sulfate, water, fiber, perlite, glass fabric, quartz powder and modifier, wherein the percentage by weight of magnesium oxide is 35% to 40%, the percentage by weight of magnesium sulfate is 20% to 25%, the percentage by weight of water is 20% to 25%, the percentage by weight of fibers is 5% to 10%, the percentage by weight of perlites is 0.5% to 0.9%, the percentage by weight of glass fabrics is 1% to 2%, the percentage by weight of quartz powder is 8% to 12%, and the percentage by weight of modifier is 0.1% to 0.5%. According to the technical solutions, the disclosed HPL may include magnesium oxide, magnesium sulfate, water, fiber, perlite, glass fabric, quartz powder and modifier according to appropriate proportions, and the product produced has low hygroscopicity, no helogenation, no rust, no discoloration, and has high anti-demolition force; moreover, magnesium sulfate has no corrosion on the glass fabric, thus, the laminate has a long life.

### FIELD OF THE INVENTION

The present invention relates to a technical field of architectural decorative materials, and in particular, to a High Pressure Laminate (HPL) and production method thereof.

### BACKGROUND

The existing HPL is usually made of glass magnesium plate. The glass magnesium plate is a made by mechanical rolling using the raw material of magnesium molding agent, glass fiber mesh cloth, packing, etc., ad it is mainly used for indoor non-load-bearing walls and ceiling, and as the substrate of various kinds of decorative boards. In prior art, usually the magnesium oxide and magnesium chloride are used as the molding agents of glass magnesium plates. In order to make magnesium fully and rapidly coagulate, the content of magnesium chloride can not be too low, otherwise it can not achieve the purpose of fully and rapidly coagulating magnesium. When the content of magnesium chloride is consistent with the purpose of full and rapid coagulation of magnesium and the content of chloride ion is too high, it is easy to cause the plate moisture absorption and helogenation. In addition, in the prior art, the glass magnesium plate is difficult to meet the national or industry standard requirements in terms of flexural strength, impact strength, shrinkage ratio, wetting ratio, screw-griping force, incombustibility and so on, which restricts the uses of glass magnesium plates in the actual production.

### SUMMARY

The main object of the present invention is to provide an HPL and the production method thereof, to enhance the anti-demolition force of the HPL and prolong its service life.

In order to achieve the above object, the invention provides an HPL, including magnesium oxide, magnesium sulfate, water, fiber, perlite, glass fabric, quartz powder and modifier, wherein the percentage by weight of magnesium oxide is 35% to 40%, the percentage by weight of magnesium sulfate is 20% to 25%, the percentage by weight of water is 20% to 25%, the percentage by weight of fibers is 5% to 10%, the percentage by weight of perlites is 0.5% to 0.9%, the percentage by weight of glass fabrics is 1% to 2%, the percentage by weight of quartz powder is 8% to 12%, and the percentage by weight of modifier is 0.1% to 0.5%.

Preferably, the percentage by weight of magnesium oxide is 36.73%, the percentage by weight of magnesium sulfate and the percentage by weight of water is both 22.95%, the percentage by weight of fibers is 6.06%, the percentage by weight of perlites is 0.7%, the percentage by weight of glass fabrics is 1.16%, the percentage by weight of quartz powder is 9.18%, and the percentage by weight of modifier is 0.27%.

Preferably, the modifier is hydrous citric acid.

The invention further provides a production method of HPL, including the following steps:

Adding the aforesaid raw materials according to a ratio to a stirring machine for stirring, and then putting the resulting mixture after stirring to a mold for setting according to the required specification, and then demoulding and drying after the mixture is formed, to get a dried plate-shaped object, and then sawing, sanding the plate-shaped object, to make an HPL.

Compared to prior art, according to the technical solutions herein, an HPL is made by magnesium oxide, magnesium sulfate, water, fiber, perlite, glass fabric, quartz powder and modifier according to appropriate proportions, and the product produced has low hygroscopicity, no helogenation, no rust, no discoloration, and has high anti-demolition force; moreover, magnesium sulfate has no corrosion on the glass fabric, thus, the laminate has a long life.

### DETAILED DESCRIPTION OF THE EMBODIMENTS

It is to be understood that the specific embodiments described herein are merely illustrative of the invention and are not intended to limit the invention.

### Example 1

Take 200 kg magnesium oxide, 125 kg magnesium carbonate, 125 kg water, 33 kg fiber, 4 kg perlite, 6 kg glass fabric, 50 kg quartz powder and 1.5 kg modifier respectively and add them to a stirring machine for stirring, and then put the resulting mixture after stirring to a mold for setting according to the required specification, and then demould and dry after the mixture is formed, to get a dried plate-shaped object, and then saw and sand the plate-shaped object, to make an HPL.

11 HPL of 18 mm can be made using the above materials according to the weights. Of which, the fibers can be one or more from bamboo fibers, woods, crop stalks and straws, etc.

Wherein, the modifier is hydrous citric acid.

According to the technical solutions herein, an HPL is made by magnesium oxide, magnesium sulfate, water, fiber, perlite, glass fabric, quartz powder and modifier according to appropriate proportion, and the product produced has low hygroscopicity, no helogenation, no rust, no discoloration, and has high anti-demolition force; moreover, magnesium sulfate has no corrosion on the glass fabric, thus, the laminate has a long life.

### Example 2

Take 190 kg magnesium oxide, 136 kg magnesium carbonate, 136 kg water, 27 kg fiber, 2.7 kg perlite, 5.4 kg glass fabric, 44.7 kg quartz powder and 2.7 kg modifier respectively and add them to a stirring machine for stirring, and then put the resulting mixture after stirring to a mold for setting according to the required specification, and then demould and dry after the mixture is formed, to get a dried plate-shaped object, and then saw and sand the plate-shaped object, to make an HPL.

Wherein the fibers can be one or more from bamboo fibers, woods, crop stalks and straws, etc.

Wherein, the modifier is hydrous citric acid.

According to the technical solutions herein, an HPL is made by magnesium oxide, magnesium sulfate, water, fiber, perlite, glass fabric, quartz powder and modifier according to appropriate proportion, and the product produced has low hygroscopicity, no helogenation, no rust, no discoloration, and has high anti-demolition force; moreover, magnesium sulfate has no corrosion on the glass fabric, thus, the laminate has a long life.

### Example 3

Take 218 kg magnesium oxide, 109 kg magnesium carbonate, 109 kg water, 54 kg fiber, 4.6 kg perlite, 5.4 kg glass fabric, 44 kg quartz powder and 0.5 kg modifier respectively and add them to a stirring machine for stirring, and then put the resulting mixture after stirring to a mold for setting according to the required specification, and then demould and dry after the mixture is formed, to get a dried plate-shaped object, and then saw and sand the plate-shaped object, to make an HPL.

Wherein the fibers can be one or more from bamboo fibers, woods, crop stalks and straws, etc.

Wherein, the modifier is hydrous citric acid.

According to the technical solutions herein, an HPL is made by magnesium oxide, magnesium sulfate, water, fiber, perlite, glass fabric, quartz powder and modifier according to appropriate proportion, and the product produced has low hygroscopicity, no helogenation, no rust, no discoloration, and has high anti-demolition force; moreover, magnesium sulfate has no corrosion on the glass fabric, thus, the laminate has a long life.

### Example 4

Take 207 kg magnesium oxide, 120 kg magnesium carbonate, 120 kg water, 43.1 kg fiber, 3.2 kg perlite, 5 kg glass fabric, 44 kg quartz powder and 2.2 kg modifier respectively and add them to a stirring machine for stirring, and then put the resulting mixture after stirring to a mold for setting according to the required specification, and then demould and dry after the mixture is formed, to get a dried plate-shaped object, and then saw and sand the plate-shaped object, to make an HPL.

Wherein the fibers can be one or more from bamboo fibers, woods, crop stalks and straws, etc.

Wherein, the modifier is hydrous citric acid.

According to the technical solutions herein, an HPL is made by magnesium oxide, magnesium sulfate, water, fiber, perlite, glass fabric, quartz powder and modifier according to appropriate proportion, and the product produced has low hygroscopicity, no helogenation, no rust, no discoloration, and has high anti-demolition force; moreover, magnesium sulfate has no corrosion on the glass fabric, thus, the laminate has a long life.

What is claimed is:

1. An HPL, comprising magnesium oxide, magnesium sulfate, water, fiber, perlite, glass fabric, quartz powder and modifier, wherein the percentage by weight of magnesium oxide is 35% to 40%, the percentage by weight of magnesium sulfate is 20% to 25%, the percentage by weight of water is 20% to 25%, the percentage by weight of fibers is 5% to 10%, the percentage by weight of perlites is 0.5% to 0.9%, the percentage by weight of glass fabrics is 1% to 2%, the percentage by weight of quartz powder is 8% to 12%, and the percentage by weight of modifier is 0.1% to 0.5%.

2. The HPL according to claim 1, wherein the percentage by weight of magnesium oxide is 36.73%, the percentage by weight of magnesium sulfate and the percentage by weight of water is both 22.95%, the percentage by weight of fibers is 6.06%, the percentage by weight of perlites is 0.7%, the percentage by weight of glass fabrics is 1.16%, the percentage by weight of quartz powder is 9.18%, and the percentage by weight of modifier is 0.27%.

3. The HPL according to claim 2, wherein the modifier is hydrous citric acid.

4. The HPL according to claim 1, wherein the modifier is hydrous citric acid.

5. A production method of HPL, comprising the following steps:
Adding the raw materials as claimed in claim 3 according to a ratio to a stirring machine for stirring, and then putting the resulting mixture after stirring to a mold for setting according to the required specification, and then demoulding and drying after the mixture is formed, to get a dried plate-shaped object, and then sawing, sanding the plate-shaped object, to make an HPL.
